(19) United States
(12) Patent Application Publication
(10) Pub. No.: US 2002/0184022 A1
(43) Pub. Date: Dec. 5, 2002

(54) Proofreading assistance techniques for a voice recognition system

(76) Inventor: Gary F. Davenport, Portland, OR (US)

Correspondence Address: FISH & RICHARDSON, PC, 4350 LA JOLLA VILLAGE DRIVE, SUITE 500, SAN DIEGO, CA, 92122, US

(21) Appl. No.: 09/876,839

(22) Filed: Jun. 5, 2001

(51) Int. Cl. G10L 17/00

(52) U.S. Cl. 704/247

(57) ABSTRACT

A system that identifies recognized words from a voice recognition system that have the lowest possibility of being correct, and flagging those words on a user interface, to help with proofreading.

### BACKGROUND

Many different dictation engines are known, including, but not limited to, those made by Dragon Systems, IBM, and others. These dictation engines typically include a vocabulary, and attempt to match the voice being spoken to the vocabulary.

It may be difficult to proofread the dictated text. Speech recognition technology relies heavily on the acoustic characteristics of words, i.e. the sound of the words that are uttered. Therefore, it is not uncommon for the recognition engine to recognize words that sound similar to the correct word but are nonsensical in context. This may make proofreading tedious, especially since other clues such as incorrect spellings, do not exist.

The dictation engines commonly use word sequences to select the best word that matches the spoken word, based on models of the language. However, the best choice might still be incorrect. Final proofreading is used for the last proofreading operation.

### BRIEF DESCRIPTION OF THE DRAWINGS

These and other aspects will now be described in detail with reference to the accompanying drawings, wherein:

FIG. 1 shows a block diagram of a computer running a speech recognition engine;

FIG. 2 shows a flowchart of operation to identify and produce an indication showing likely misrecognition candidates; and

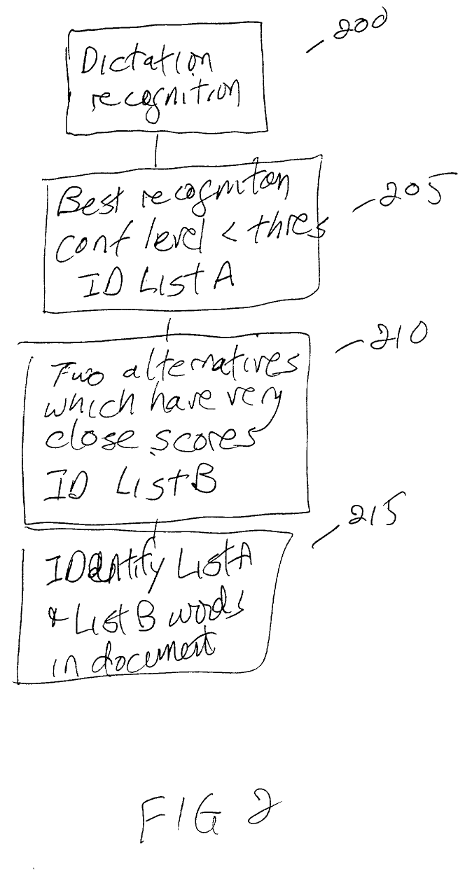

FIG. 3 shows an exemplary user interface with the likely misrecognition candidates being indicated.

### DETAILED DESCRIPTION

The present system teaches a technique of using confidence levels generated by the speech recognition engine to analyze a document. The user interface is also modified to provide a view of the document which includes information about the confidence level. In an embodiment, this system may use lists of words which are already produced by the dictation engine.

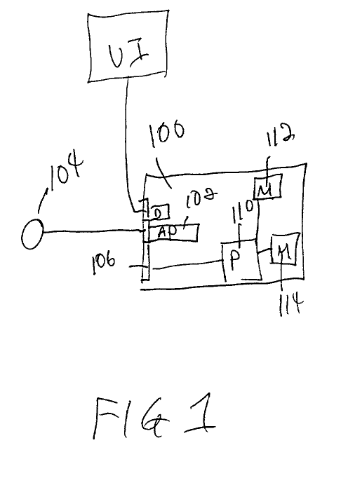

FIG. 1 shows a basic embodiment of the system. A computer system 100 includes an audio processing unit 102 which has a connection to a microphone 104. The audio processing unit 102 may include, for example, a sound card. The audio processing unit 102 is connected via a bus, e.g. via the PCI bus, to processor 110 which is driven by stored instructions in memory 112. The processor may also include associated working memory 114, which may include random access memory or RAM of various types, including internal RAM to the processor. The processor operates based on instructions in a known way.

In an embodiment, the stored instructions may include a commercial dictation engine, such as the ones available from Lernout and Hauspie, Dragon Systems, IBM and/or Phillips.

When recognizing an utterance, speech engines often produce two different items. First, an Alts List may be produced. The Alts list includes at least one, but usually more than one, recognition candidate for each recognized word or phrase. Commonly, the recognition candidate that has the highest score is taken as the best candidate, and eventually inserted into the text. Various techniques, including word sequence modelling from a statistical language model may be used along with other models, such as an acoustic model to produce confidence scores.

Each recognition candidate, whether a phrase or a single word, is associated with a corresponding confidence value. The confidence value quantifies the confidence of the recognizer that the word or phrase correctly corresponds with the user utterance. Confidence values are often based on a combination of the language model that is used, and the acoustic model that does the scoring. The best solution may be obtained from both language model and each acoustic model scores. However, different techniques may be used to find the best match.

While the different dictation engines may have different names for these variables, virtually all dictation engines are believed to produce a list of the different candidates and somehow score the likelihood that the current word is the correct candidate.

The present system uses these variables to identify situations where it is likely that recognitions error have occurred. The system operates in conjunction with the dictation recognition engine which is shown in 200. At 205, the system first recognizes a situation where the best recognition has a confidence level less than a predefined threshold. For example, the predefined threshold may define the confidence level, e.g., less than 50 percent correct, or less than 70 percent correct. These values are used to form a first list, called list A. Another technique may use a percentile approach, where the lowest 5 percentile of confidence levels are identified.

At 210, the system identifies two alternatives which have very close scores, e.g., close enough that accurate detection of one or the other might not be possible. Again, this may use a system of percentile ratings. The scores lying in the top 5 percentile closest scores are taken as unusually close confidence ratings. These values obtained at 210 are used to form a second list, referred to as list B.

Hence, during the dictation, list A. may include a list of all words or phrases with the lowest confidence levels. This aim may be arranged in an ascending sort, such as in the following:

Pea 30

Farm 31

Car 32

Truck 35.

List B is also formed during the dictation. List B corresponds to a descending sort of all words or utterances whose top two or three recognition candidates vary within a margin that is very narrow as described above. The entries in list B might look like the following.

Eight 85

Ate 83

Bait 80.

By following the operations in 205 and 210, lists a and B. are formed for the entire document.

At 215, the list A. and list B. words are identified. The user interface is modified to show at least some of the list A. and list B. words in the document. For example, a user can select to have more words shown, e.g., all the words in both of lists A and B. As an alternative, only some of these words may be shown in the document. Since the lists are ordered, only the top x% of the words may be selected, in another embodiment.

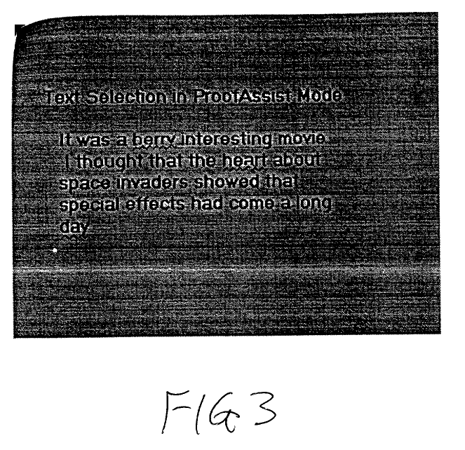

In one embodiment, shown in FIG. 3, the words on the list may be highlighted within the document. The highlighting may be carried out by underlining with a squiggly line, which denotes that these words are the most likely words to be incorrect. Other highlighting techniques may use different colors for the words, different fonts for the words, or anything else that might indicate that the words are likely misrecognition candidates. By doing this, the users may be advised of likely misrecognitions, thereby making it easier to proofread such a document.

Although only a few embodiments have been disclosed in detail above, other modifications are possible. For example, the alteration of the user interface may be carried out to show different things other then squiggly lines. The words may be highlighted or shown in some other form. In addition, other techniques may be used besides these described above to obtain either alternative lists, or additional lists. All such modifications are intended to be encompassed within the following claims, in which:

What is claimed is:

1. A method, comprising:
operating a speech recognition engine to recognize spoken words, by forming a first group of likely words to correspond to a spoken word, and associating values with said likely words, which values correspond to a likelihood that the likely word corresponds to the correctly-spoken word;
first identifying a first plurality of words which have confidence levels, representing a confidence that the word has been correctly recognized, less than a specified threshold;
second identifying a second plurality of words which have close scores to other likely words; and
displaying said recognized spoken words, with an indication that highlights said recognized spoken words which are within said first plurality of words or said second plurality of words.

2. A method as in claim 1, wherein said first identifying comprises determining a word which is recognized, determining a confidence level of said word which is recognized, and forming a first list of words which are recognized which have a confidence level less than a specified amount, as said first identifying.

3. A method as in claim 1, wherein said second identifying comprises determining a best scored recognized word, determining other candidates for said best scored recognized word, determining confidence levels of said best scored recognized word and said other candidates, determining said best scored recognized words and said other candidates which have recognition values which are closer than a specified value, and forming a second list of words which have said recognition values that are closer than a specified value, as said second identifying.

4. A method as in claim 2, wherein said second identifying comprises determining a best scored recognized word, determining other candidates for said best scored recognized word, determining confidence levels of said best scored recognized word and said other candidates, determining said best scored recognized words and said other candidates which have recognition values which are closer than a specified value, and forming a second list of words which have said recognition values that are closer than a specified value, as said second identifying.

5. A method as in claim 4, further comprising sorting said first and second lists according to confidence levels.

6. A method as in claim 1, wherein said second indication comprises a squiggly line marking a word on one of said first and second lists.

7. A method as in claim 4, wherein said second indication marks only some words of the words on said lists, according to an order of said sorting.

8. A method as in claim 1, wherein said confidence levels are based on scoring a recognition according to at least one model.

9. A method as in claim 8, wherein said confidence level are based on scoring from both of than a language model and from and acoustic model.

10. An apparatus, comprising:
a memory,
a user interface;
a sound input element, operating to obtain input sound;
a computer processing element, operating based on instructions in the memory, and based on the input sound, to run a voice recognition engine, recognizing words in the input sound, and produces a plurality of likely recognition candidates based on the recognizing, along with information confidence in the recognition candidates, said processing element producing a list of information in said memory indicating a first group of words which have been recognized, but have a recognition less than a specified amount, and a second group of words which have been recognized, but are sufficiently close to other group of words, and said processing element operative to mark, on said user interface, said first and second groups of words.

11. An apparatus as in claim 10, wherein said first group comprises a first list of words in said memory which have a confidence score, indicating a confidence in a recognition, which is less than a specified threshold.

12. An apparatus as in claim 10, wherein said second group comprises a second list of words in said memory, which have recognition values that are very close to other possible words corresponding to the recognition.

13. An apparatus as in claim 11, wherein said second group comprises a second list of words in said memory, which have recognition values that are very close to other possible words corresponding to the recognition.

14. An apparatus as in claim 13, wherein said lists are sorted according to a prespecified criteria.

15. An apparatus as in claim 10, further comprising a display forming element, forming a display indicating recognized words in the input sound, and wherein said marking comprises marking said recognized words.

16. An apparatus as in claim 15, wherein said marking comprises underlined in said recognized words with a squiggly line.

17. A method as in claim 10, wherein said first and second groups of words are formed based on recognition according to at least one of a language model and an acoustic model.

18. An article comprising a computer-readable medium which stores computer-executable instructions for recognizing text within spoken language, the instructions causing a computer to:
operate a speech recognition engine to recognize spoken words which are input to a computer peripheral, by first identifying a plurality of recognized words for each block of spoken words, identifying confidence values which indicate a confidence in the recognized words, and select one of said block as a best selection among the plurality of recognized words;
identifying a first group of best selections which have confidence values less than a specified threshold;
identifying a second group of best selections where the best selection, and at least one other of said plurality of words, has a confidence value difference of less than a specified value; and
providing a display indicating recognized spoken words, and forming an indication on the display of those recognition results which have less than a specified amount of confidence in the results.

19. A computer as in claim 18, which is further programmed to carry out said recognition and form said first and second groups based on both of a language model and an acoustic model.

20. A computer as in claim 18, further comprising sorting said lists according to confidence levels, and taking only a specified number of items from said sorted lists, from a specified end of said sorted lists which provides only those items which are most likely to be incorrect on said user interface.

21. A computer as in claim 18, wherein said indication is a squiggly line underlining specified recognition results which have less than said specified amount of confidence.

22. A computer as in claim 20, further comprising taking only specified values from said lists.
